(19) United States
(12) Patent Application Publication
(10) Pub. No.: US 2011/0003218 A1
(43) Pub. Date: Jan. 6, 2011

(54) Device, Method and System for Producing Thermal and/or Kinetic and Electrical Energy

(75) Inventors: Ralf-Henning Stolte, Hamburg (DE); Martin Saballus, Damlos (DE)

Correspondence Address: Sunstein Kann Murphy & Timbers LLP, 125 SUMMER STREET, BOSTON, MA, 02110-1618, US

(73) Assignees: AIRBUS DEUTSCHLAND GMBH, Hamburg (DE); DEUTSCHES ZENTRUM FUR LUFT- UND RAUMFAHRT E.V., Koln (DE)

(21) Appl. No.: 12/293,468

(22) PCT Filed: Mar. 20, 2007
(86) PCT No.: PCT/EP07/52662

§ 371 Date: Oct. 14, 2009

(30) Foreign Application Priority Data
Mar. 20, 2006 (DE) 10 2006 013 037.5

(51) Int. Cl. H01M 8/06

(52) U.S. Cl. 429/416

(57) ABSTRACT

The present concerns an apparatus (5, 105) for energy production from a hydrocarbon mixture (15) having at least one dehydrogenatable compound, in particular from a hydrocarbon-based fuel, preferably from kerosene, comprising a tank (10, 110) for providing the hydrocarbon mixture (15), and a combustion machine (20, 120) connected to the tank (10, 110) for combustion of hydrocarbons for producing thermal and/or kinetic energy (25, 125, 30, 130). To provide such an apparatus (5, 105), a corresponding method and a corresponding system in which thermal, kinetic and electrical energy (25, 125, 30, 130, 55, 155) is efficiently produced it is proposed that the apparatus (5, 105) further comprises a separating device (35, 135) for at least partially separating the at least one dehydrogenatable compound from the hydrocarbon mixture (15), dehydrogenating means (40, 140) for producing hydrogen from the separated dehydrogenatable compound by dehydrogenation, first feed means (45, 145) for directly or indirectly feeding the dehydrogenated compound to the combustion machine (20, 120), and a fuel cell (50, 150) for producing electrical energy (55, 155), with reaction of the hydrogen obtained.

The present invention concerns an apparatus for energy production from a hydrocarbon mixture having at least one dehydrogenatable compound, in particular from a hydrocarbon-based fuel mixture, preferably from kerosene, comprising a tank for providing the hydrocarbon mixture, and a combustion machine connected to the tank for combustion of hydrocarbons for producing thermal and/or kinetic energy. The invention further concerns a corresponding system and a corresponding method.

Aircraft of the ‘Airbus’ type, besides the classic aircraft turbines as main assemblies which in operation provide for forward propulsion of the aircraft and which can also be used for generating electrical energy hitherto have a further turbine as an auxiliary assembly or ‘auxiliary power unit’ (APU) which for example, when the main assemblies are switched off, can supply the aircraft on board with electrical energy. When kerosene is burnt in that, APU exhaust gases are produced, for which operators of airports in many cases demand additional charges. Those additional charges increase the costs of operating the aircraft and thus have an adverse effect on its economy.

One possible way of producing electrical energy without in that case generating unwanted exhaust gases involves the reaction of hydrogen with oxygen to give water, for example in a fuel cell.

It is however comparatively complicated and expensive to provide the hydrogen as such. Particularly in the case of an aircraft, in part for safety reasons and in part for reasons of saving weight, it is not viable to carry hydrogen itself as an energy carrier in gas form or in liquefied form. It therefore appears advantageous for the hydrogen to be first produced or provided in operation directly for use.

A conventional manner of providing or producing hydrogen involves reacting a hydrocarbon mixture, for example a hydrocarbon-based fuel such as kerosene or benzene in an autothermal reforming procedure (ATR) at a working temperature of between 800° C. and 1200° C. to give hydrogen (yield: 20-30%), carbon monoxide (CO, up to 10%), methane (up to 1%) and balance substances. The molar hydrogen yield in a dry reformate is between 40% and 55% after a gas cleaning operation.

By way of example DE 199 24 778 A1, DE 101 57 737 A1, DE 103 36 759 A1 and DE 103 38 227 A1 disclose methods and apparatuses in which a proportion of fuel is taken off from a fuel mixture, for example in the form of a distillation, which is then fed to a reformer, wherein the fuel is split up in the reformer in known fashion, as described above.

However, with that form of hydrogen production, by-products (inter alia methane) are also given off, so that this does not afford complete freedom from waste gases. Furthermore a highly complex system is required, which also manifests itself in terms of system weight and volume. An autothermal reforming system has an inertia which, in relation to dynamic demands, can lead to a reduction in the system operating life and/or a more complex system architecture. The high temperature difference between the autothermal reforming operation (800° C.-1200° C.) and the PrOx stage (120° C.-150° C.) is also disadvantageous. Overall therefore that procedure for hydrogen production is unsuitable in particular for use in an aircraft.

Various methods are known in which hydrogen which was obtained for example by the electrolysis of water is stored or bound in a suitable fashion and is then only liberated again for use. By way of example hydrogen can be stored in the form of metal hydride. Another method of hydrogen transport is described by S Hodoshima et al in ‘Catalytic decalin dehydrogenation/naphthalene hydrogen pair as a hydrogen source for fuel-cell vehicle’ (International Journal of Hydrogen Energy 28 (2003) 1255-1262). In that case decalin is used as a hydrogen source on an aircraft propelled by a fuel cell, where the decalin is dehydrogenated to give naphthalene to liberate the hydrogen contained therein. The naphthalene is stored in the aircraft and is later discharged again for hydration thereof. After hydration of the naphthalene decalin is thus available again, this therefore providing a closed circuit (decalin, naphthalene).

Providing the hydrogen by means of a conventional carrier medium of that kind suffers from the disadvantage that the carrier medium itself represents an additional weight loading which is unacceptable in particular in an aircraft as the carrier medium and in particular the carrier medium from which the hydrogen has been removed does not serve any further purpose and is thus to be considered as a ‘dead weight’.

Therefore an object of the present invention is to provide an apparatus, and a method and a system in which thermal, kinetic and electrical energy is efficiently produced. In particular the invention aims to use hydrogen as an energy carrier in a simple and efficient manner to avoid or reduce unwanted waste gas emissions. The invention seeks to provide that the provision of the hydrogen is ensured in particular without major temperature differences within the apparatus and with the least possible ‘dead weight’.

In accordance with a first aspect of the invention, to attain that object, there is proposed an apparatus for producing energy from a hydrocarbon mixture having at least one dehydrogenatable compound, in particular from a hydrocarbon-based fuel, preferably from kerosene, comprising: a tank for providing the hydrocarbon mixture and a combustion machine connected to the tank for combustion of hydrocarbons for producing thermal and/or kinetic energy, wherein the apparatus further comprises a separating device for at least partially separating the at least one dehydrogenatable compound from the hydrocarbon mixture, dehydrogenating means for producing hydrogen from the separated dehydrogenatable compound by dehydrogenation, first feed means for directly or indirectly feeding the dehydrogenated compound to the combustion machine, and a fuel cell for producing electrical energy, with reaction of the hydrogen obtained.

Furthermore in accordance with a second aspect of the invention there is proposed a system for energy production comprising an apparatus according to the invention and a hydrocarbon mixture having at least one dehydrogenatable compound, in particular a hydrocarbon-based fuel, preferably kerosene.

In connection with the present invention the term ‘hydrocarbon mixture’ is not limited to hydrocarbon mixtures based on fossil sources or from fossil sources, but the term also embraces hydrocarbon mixtures produced in any other fashion, in particular synthetic fuels and bio-fuels, in particular from renewable energy sources.

In accordance with a further aspect of the invention there is proposed a method of producing energy from a hydrocarbon mixture having at least one dehydrogenatable compound, in particular from a hydrocarbon-based fuel, preferably from kerosene, comprising the steps: providing the hydrocarbon mixture, and burning hydrocarbons for producing thermal and/or kinetic energy, wherein the method includes as further steps: at least partially separating at least one predetermined dehydrogenatable compound from the hydrocarbon mixture, producing hydrogen from the separated dehydrogenatable compound by dehydrogenation, indirectly or directly feeding the dehydrogenated compound to the combustion machine, and reacting the hydrogen produced to produce electrical energy.

The invention is based on the realisation that a hydrocarbon mixture which can be used as a conventional energy carrier source for a combustion machine can additionally also be used as a hydrogen carrier if the hydrocarbon mixture has at least one dehydrogenatable compound, wherein the hydrogen can be removed from the at least one dehydrogenatable compound and the dehydrogenated compound itself is in turn used as the energy carrier source for the combustion machine. In that way the hydrocarbon mixture serves both as a hydrogen carrier (energy carrier source for a fuel cell) and also as an energy carrier source (for the combustion machine), whereby it is possible to dispense with providing unnecessary ‘dead weight’, for provision of hydrogen. A suitable way of separating off the dehydrogenatable compound from the hydrocarbon mixture makes it possible to obtain the hydrogen specifically from the dehydrogenatable compound without further compounds contained in the hydrocarbon mixture adversely affecting the production of the hydrogen or in turn being adversely affected by the hydrogen production process.

The term ‘combustion machine’ in the context of the present invention stands for a thermal engine in which the hydrocarbon mixture is oxidised or undergoes combustion to produce thermal and/or kinetic energy. Examples of combustion machines in accordance with the invention are internal combustion engines, gas turbines and steam turbines. Combustion machines of particular interest in the present context are jet engines used in aircraft, in particular turbojet engines.

It can be provided that only one individual element serves as a combustion machine, for example an individual turbine. On the other hand however it is also possible for a plurality of turbines to represent together the combustion machine. In that respect it is also possible for the turbines to be of different types and for example to make different demands on the hydrocarbons fed to them.

Separation of the at least one dehydrogenatable compound divides at least a portion of the hydrocarbon mixture into at least two parts. One part includes at least a part of the at least one dehydrogenatable compound and the other part or parts includes or include the remaining residue. The other part can therefore be referred to as the ‘hydrocarbon mixture residue’. The invention is not limited to separating off solely a single dehydrogenatable compound from the hydrocarbon mixture, although that is advantageous in many cases. When separating off the at least one dehydrogenatable compound, other compounds can also be separated off therewith, even other non-dehydrogenatable compounds. It is advantageous in many cases for a plurality of dehydrogenatable compounds to be jointly separated off. In the extreme case moreover the at least one dehydrogenatable compound can be at least partially separated off together with the large part of the hydrogen mixture (including non-dehydrogenatable compounds) from a single unwanted compound which then represents the ‘hydrocarbon mixture residue’.

Although as complete separation as possible of the dehydrogenatable compound from the hydrocarbon mixture residue is preferred, the reference to separation in the present context is used to denote any separation procedure whereby the separated parts or portions are of different compositions or in which the concentration of the dehydrogenatable compound is increased in one of the parts and reduced in another part.

In a further configuration of the invention the apparatus comprises second feed means for indirectly or directly feeding the hydrocarbon mixture residue remaining upon separation of the at least one dehydrogenatable compound to the combustion machine.

If a part of the hydrocarbon mixture provided is fed to the separating device for separating off the at least one dehydrogenatable compound, and the residue of the hydrocarbon mixture, which remains of that part after the separation operation, is in turn fed to the combustion machine, that provides that the hydrocarbon mixture afforded is very substantially utilised.

In a further configuration of the apparatus according to the invention the separating device includes a distillation device for distillative separation of a fraction containing the dehydrogenatable compound and/or a sorption device for sorptive separation of the at least one dehydrogenatable compound from the hydrocarbon mixture.

A distillation operation represents a simple and efficient possible way of separating a dehydrogenatable compound from the hydrocarbon mixture. In that case, by suitable control of the distillation operation, it is possible to specifically and targetedly set which constituents, besides the dehydrogenatable compound, are still present in the fraction. In particular it is possible in a distillation operation to provide in a specifically targeted fashion that given constituents or components of the hydrocarbon mixture are not transferred or are only limitedly transferred into the fraction.

An alternative or supplemental mode of separation involves providing with the sorption device, means which are adapted to absorb and/or adsorb at least the one dehydrogenatable compound to remove it from the hydrocarbon mixture in that way, wherein absorption and/or adsorption is (at least partially) reversible (to liberate at least the one dehydrogenatable compound). In per se known manner that sorptive separation operation can also be carried out in a continuous process. In addition in accordance with the invention it can be provided that the sorption device can be introduced into the tank in order to separate at least one dehydrogenatable compound from the hydrocarbon mixture which in operation is disposed in the tank.

It will be noted that, besides the preferred methods of distillation and sorption, it is also possible to use other separation methods in accordance with the invention.

In a further configuration of the apparatus according to the invention the separating device is adapted to at least partially free the dehydrogenatable compound or compounds in the separation operation from a predetermined impurity.

In a further processing operation, in particular in the dehydrogenation step, in respect of the dehydrogenatable compound or compounds which has or have been separated off, one or more given compounds contained in the hydrocarbon mixture may constitute an impediment or indeed may be harmful and thus can represent an impurity which is to be avoided. It is therefore advantageously to be provided that a compound which is to be viewed as an impurity is not separated out of the hydrocarbon mixture at all, or at least only in a sufficiently reduced level of concentration, together with the dehydrogenatable compound.

That cleaning operation or at least partial removal of the impurity can also be carried out in a separate process step in a different fashion from the remaining separation procedure. Thus it is possible for example to use a suitable distillation operation to separate off at least one dehydrogenatable compound which in addition is at least partially freed of the impurity by means of absorption or adsorption thereof. The sequence in which the sub-steps in the separation operation are effected can be freely selected by the man skilled in the art. In the case of a combination of distillation and sorption (for cleaning purposes) however it is preferable for the distillation operation to be carried out as the first sub-step prior to the cleaning procedure.

In an advantageous configuration of the apparatus according to the invention the first and/or second feed means are adapted to feed the dehydrogenated compound and the hydrocarbon mixture residue respectively to the combustion machine via the tank.

There is no need for the dehydrogenated compound or the hydrocarbon mixture residue to be passed directly to the combustion machine. The first and/or second feed means can also be intended in operation to introduce the dehydrogenated compound or the hydrocarbon mixture residue remaining in the separation operation into the tank, for example to mix it there with the hydrocarbon mixture in the tank or to dissolve it therein. That is particularly advantageous when the properties of the dehydrogenated compound or the hydrocarbon mixture residue do not solely fulfil the demands of the combustion machine on a fuel, but it will be noted that the properties of the hydrocarbon mixture, in respect of that demand, are not changed or are only immaterially changed by the addition of dehydrogenated compound or hydrocarbon mixture residue respectively.

In a preferred configuration the apparatus is adapted for processing an aircraft kerosene (as the hydrocarbon mixture) and the separating device is adapted to separate one or more dehydrogenatable compounds from the aircraft kerosene (hydrocarbon mixture), which are selected from the group consisting of cyclohexane, methylcyclohexane, cis-decalin, trans-decalin, n-dodecane, tetralin, dipentene, diethylbenzene and mixtures thereof.

It was found that the invention can be particularly advantageously used in an aircraft with aircraft kerosene as the hydrocarbon mixture, in which case then inter alia cyclohexane, methylcyclohexane, cis-decalin, trans-decalin, n-dodecane, tetralin, dipentene and diethylbenzene are available as particularly advantageous dehydrogenatable compounds. It will be noted however that the above-mentioned compounds are in part also included in diesel fuels and automobile gasoline so that the invention can also be excellently well used in motor vehicles whose internal combustion engines are designed for those fuels.

In a further configuration of the apparatus according to the invention the dehydrogenating means include a catalyst for catalytic dehydrogenation of the dehydrogenatable compound.

Catalytic dehydrogenation has the advantage over thermal dehydrogenation which in accordance with the invention is also possible that the dehydrogenatable compound does not have to be greatly heated to provide for liberation of the hydrogen.

Particularly suitable catalysts, catalyst arrangements and catalytic dehydrogenation methods can be found for example from the publications by S Hodoshima et al: ‘Catalytic decalin dehydrogenation/naphthalene hydrogenation pair as a hydrogen source for fuel-cell vehicle’ (International Journal of Hydrogen Energy 28 (2003) 1255-1262) and ‘Hydrogen storage by decalin/naphthalene pair and hydrogen supply to fuel cells by use of superheated liquid-film-type catalysis’ (Applied Catalysis A: General 283 (2005) 235-242) as well as the publications by N Kariya et al: ‘Efficient evolution of hydrogen from liquid cycloalkanes over Pt-containing catalysts supported on active carbons under wet-dry multiphase conditions’ (Applied Catalysis A: General 233 (2002) 91-102) and ‘Efficient hydrogen production using cyclohexan and decalin by pulse-spray mode reactor with Pt catalysts’ (Applied Catalysis A: General 247 (2003) 247-259). Catalytic dehydrogenation with the dehydrogenatable compound in the liquid phase has the advantage of requiring a smaller amount of energy, in which respect it will be noted however that a lower hydrogen yield is generally also achieved. If the dehydrogenatable compound is to be put into the gaseous phase in order then to be subjected to catalytic dehydrogenation, an increased amount of energy is required for that purpose. It will be noted however that a catalytic reaction in the gaseous phase has a generally accelerated reaction kinetic. Conditions in which the dehydrogenatable compound is present in the state of a superheated liquid with a saturated gaseous phase were found to be advantageous.

A further advantageous configuration of the invention concerns an apparatus according to the invention with a control unit for controlling the separating device, and an analysis unit connected to the control unit for analysing the composition of a provided hydrocarbon mixture in operation, wherein the control device is adapted in operation to control the amount of the hydrocarbon mixture, that is fed to the separating device, and separation of the at least one dehydrogenatable compound therefrom on the basis of the composition determined by the analysis unit.

In general for example kerosene, not just a single dehydrogenatable compound, is present in a typical hydrocarbon mixture. There is generally a series of dehydrogenatable compounds. Even if there is only one respective dehydrogenatable compound present in a given hydrocarbon mixture, there can be another dehydrogenatable compound present in another hydrocarbon mixture. If the apparatus is equipped with an analysis unit and the analysis unit is connected to the control unit so that data in respect of the composition of a hydrocarbon mixture which is encountered in operation can be passed to the control unit, that has the advantage that this apparatus can be flexibly set for processing the respectively present hydrocarbon mixture with the one dehydrogenatable compound or with the existing dehydrogenatable compounds. In that way in that configuration the apparatus can be operated with a multiplicity of different hydrocarbon mixtures.

In addition in a further configuration of the invention the control unit is further adapted in operation to ensure production of a predetermined amount of hydrogen per unit of time.

If for example there are a plurality of different dehydrogenatable compounds in the hydrocarbon mixture encountered in operation, it is thus possible by means of the analysis unit to identify the dehydrogenatable compounds present and to control the amount of hydrocarbon mixture which is fed to a separation operation, and separation or division of the hydrocarbon mixture, in such a way that a desired amount of hydrogen per unit of time can always be produced. In that way it is possible to satisfy a substantially continuous power requirement by reaction of the hydrogen.

In another configuration of the invention the control unit is further adapted in operation to ensure production of hydrogen for a predetermined period of time.

It is possible, by control of the amount of hydrocarbon mixture provided for separation and by control of the separation operation itself, in regard to the compound or compounds which is or are separated off, to ensure that a predetermined minimum amount of hydrogen is available at any moment in time over a desired period of time. It will be noted that it is also possible to provide that the minimum amount of hydrogen is not produced continuously but the system ensures that hydrogen production can be begun at any desired moment in time within the predetermined period of time.

In a preferred configuration of the apparatus according to the invention the control device is further adapted to control the manner of feeding the dehydrogenated compound and/or the hydrocarbon mixture residue remaining upon separation of the at least one dehydrogenatable compound to the combustion machine.

In principle there are two possible ways or processes for feeding the dehydrogenated compound to the combustion machine. On the one hand the dehydrogenated compound can be fed directly to the combustion machine. In that respect ‘directly’ or ‘immediately’ means that the feed is effected substantially without intermediate storage. In this connection, a feed by way of a conduit from the separating device to the combustion machine is to be considered as direct. Indirect feed is afforded for example if the dehydrogenated compound is put into intermediate storage in a tank. That tank can be the tank provided for the hydrocarbon mixture so that in operation the dehydrogenated compound is mixed with the hydrocarbon mixture in the tank, prior to being fed to the combustion machine. Another mode of indirect feed provides that there is a dedicated separate tank for intermediate storage and the dehydrogenated compound is fed to the combustion machine from that tank.

The description set forth in the preceding paragraph also correspondingly applies to the feed of the hydrocarbon mixture residue which is left after feed of an amount of hydrocarbon mixture to the separating device and separation of the dehydrogenatable compound, to the combustion machine. It can also be provided that the hydrocarbon mixture residue and the dehydrogenated compound are mixed together, prior to a feed to the combustion machine, separately from the remaining hydrocarbon mixture.

In a further advantageous configuration of the apparatus according to the invention the control unit is further adapted in operation to ensure that predetermined properties of the totality of hydrocarbons, that is fed to the combustion machine, lie within predetermined tolerance ranges.

On the basis of the data obtained by means of the analysis unit, relating to the composition of the hydrocarbon mixture, it is possible to determine the way in which removal of the dehydrogenatable compound acts on the hydrocarbon mixture and its properties. Accordingly, it is also possible to determine the influence of recycling of the dehydrogenated compound and/or the hydrocarbon mixture residue which occurs in a separation operation, into the hydrocarbon mixture. The operation of determining those properties can be effected for example on the basis of empirical data or can be based on suitable simulation calculations. Particularly in the aircraft sector, special demands are made on the fuel kerosene in regard to its properties. For example the melting temperature of the kerosene is not to exceed a predetermined value. In the vehicle sector, fuels such as gasoline or premium gasoline must satisfy given demands, for example in respect of their octane number. If removal of the dehydrogenatable compound or recycling of the dehydrogenated compound or the hydrocarbon mixture residue to the hydrocarbon mixture prior to combustion in the combustion machine leads to a worsening of one or more properties of the hydrocarbon mixture, then, in accordance with this embodiment of the invention, the entire process is controlled in such a way that the properties of the totality of hydrocarbons fed to the combustion machine (for example of a mixture including dehydrogenated compound and hydrocarbon mixture residue) do not exceed or fall below predetermined threshold values. By way of example that can be effected by a procedure whereby, after separation of a part of a first dehydrogenatable compound, another dehydrogenatable compound is separated off, or the dehydrogenatable compound or compounds is or are separated off in a varied amount. It can also be provided that implementation of the method according to the invention is interrupted if the desired parameter ranges would otherwise no longer be observed.

In a further configuration of the invention the control unit has a calculating unit which is adapted to determine an implementation in respect of time of the amount of hydrocarbon mixture fed to the separating device, separation of the at least one dehydrogenatable compound in the separating device, and/or the way of feeding the dehydrogenated compound and/or the hydrocarbon mixture residue remaining upon separation of the at least one dehydrogenatable compound to the combustion machine on the basis of the composition determined by the analysis unit so that in that implementation it is ensured that for a predetermined period of time in operation predetermined properties of the totality of hydrocarbons, that is fed to the combustion machine, lie within predetermined tolerance ranges.

Advantageously in that configuration the overall implementation of the production of hydrogen is determined over a given period of time, using the items of information determined by the analysis unit, in relation to the composition of the hydrocarbon mixture. In particular in calculating the implementation in respect of time it is possible to establish whether and in what manner the desired tolerance ranges can be maintained, for the desired period of time. If for example it is detected when fuelling an aircraft with the apparatus according to the invention that, with the available fuel, the method according to the invention cannot be carried out in the desired manner for the entire length of the mission, then suitable precautions can be taken in good time to eliminate or circumvent that problem.

In an advantageous configuration of the invention it has a mixing unit for the production of a mixture from the hydrocarbon mixture, the hydrocarbon mixture residue remaining upon separation of the at least one dehydrogenatable compound, and the dehydrogenated compound in predetermined portions, and a measuring unit for measuring predetermined properties of the mixture.

By means of the mixing unit it is possible to investigate the process of mixing dehydrogenated compound, hydrocarbon mixture residue and hydrocarbon mixture under given process conditions without the method according to the invention actually having to be carried out with those parameters. In that way it is possible in real time to determine by the apparatus itself, by means of the measuring unit, what effects such a mixing operation has on the properties of the mixture. Thus it is possible for example to obtain specific data, on the basis of which it is possible to prognosticate the implementation in respect of time of the method according to the invention.

In a further configuration the apparatus according to the invention is equipped with a water storage means for receiving water produced in the fuel cell.

The water produced upon reaction of the hydrogen in the fuel cell on board an aircraft can be used for example as service water, thereby affording a weight saving in that less water has to be carried on the aircraft from the start.

The system according to the invention preferably includes an apparatus according to the invention in a preferred embodiment as described hereinbefore.

A method according to the invention is preferably carried out using a system according to the invention.

Further preferred configurations of the invention are set forth in the examples hereinafter and the claims.

The invention is described in greater detail hereinafter by means of preferred embodiments with reference to the accompanying diagrammatic drawings in which:

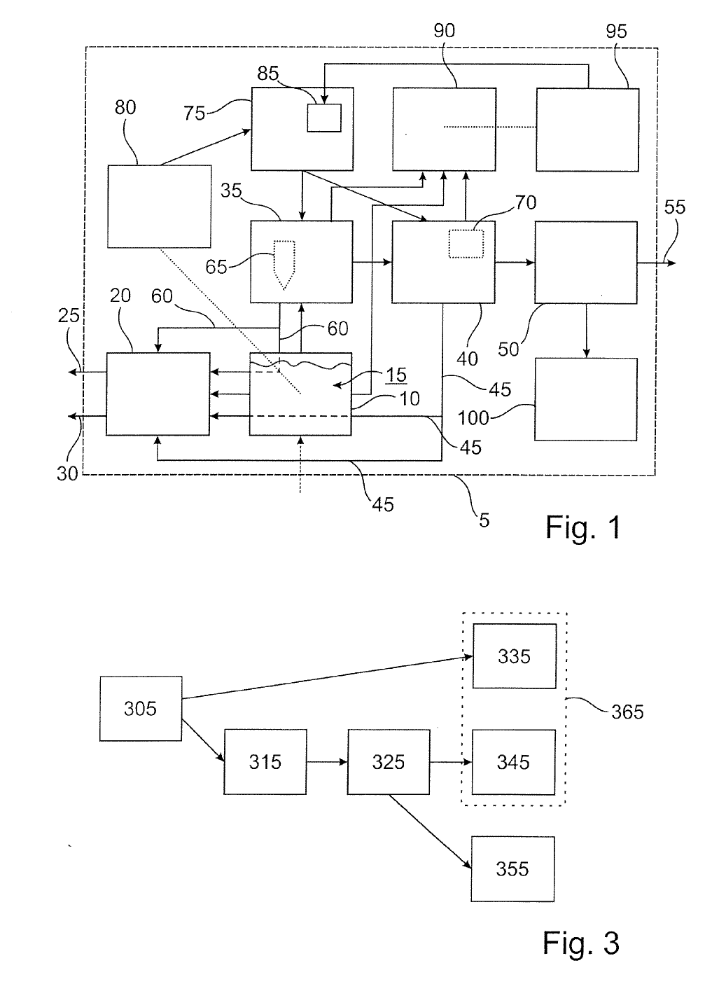

FIG. 1 shows a first embodiment of an apparatus according to the invention with a hydrocarbon mixture,

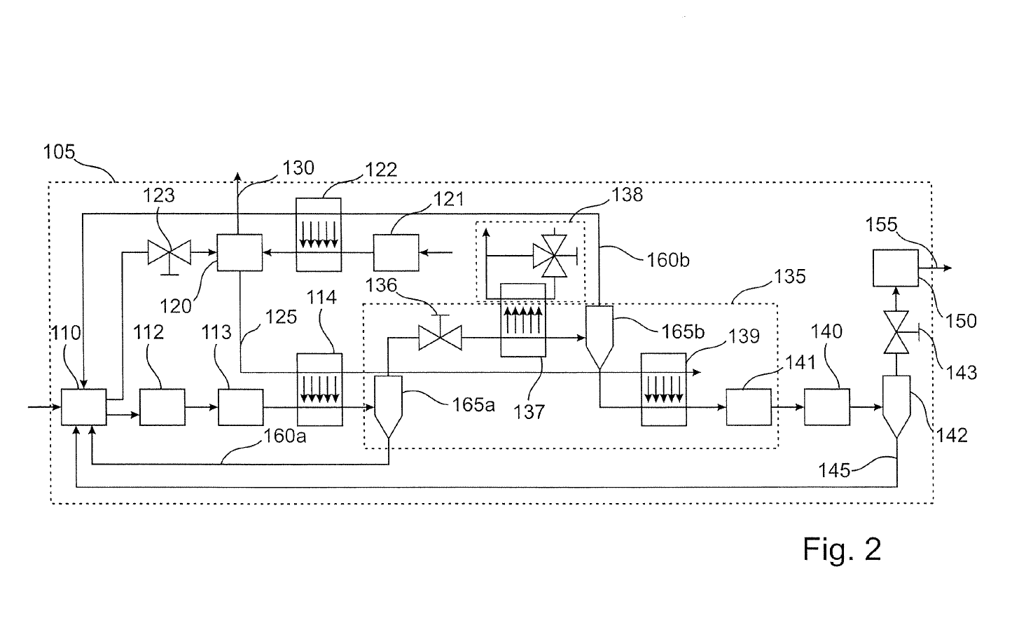

FIG. 2 shows a second embodiment of an apparatus according to the invention,

FIG. 3 shows a flow chart to illustrate a first embodiment of the method according to the invention, and

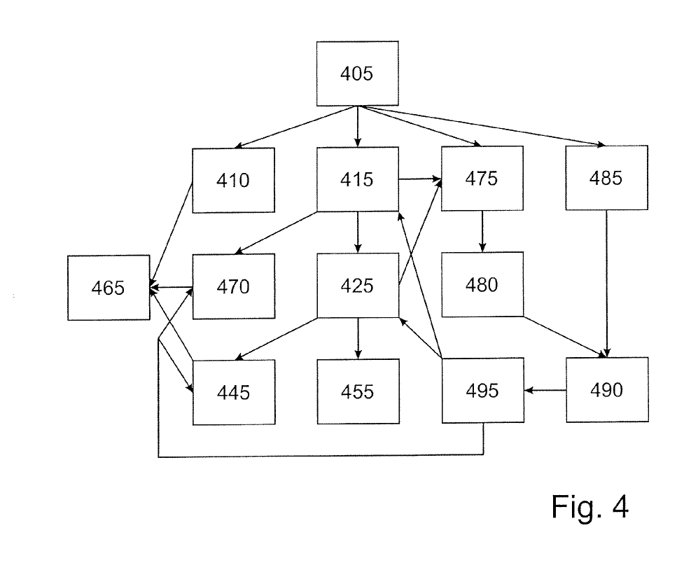

FIG. 4 shows a flow chart to illustrate a second embodiment of the method according to the invention.

FIG. 1 diagrammatically shows a first embodiment of an apparatus according to the invention with a hydrocarbon mixture. The apparatus 5 for producing energy has a tank 10 which here contains a liquid hydrocarbon mixture 15, a combustion machine 20 connected to the tank, a separating device 35 also connected to the tank, dehydrogenating means 40, first feed means 45 connecting the dehydrogenating means to the tank and the combustion machine respectively, and a fuel cell 50. The apparatus further has second feed means 60 connecting the separating device 35 and the combustion machine 20 and the tank 10 respectively. The separating device 35 has an element 65 for fractionated distillation. The dehydrogenating means 40 include a catalyst 70. The apparatus further includes a control unit 75 connected to the separating device 35 and the dehydrogenating means 40, with a calculating unit 85, an analysis unit 80, a mixing unit 90, a measuring unit 95 and a water storage means 100.

The liquid hydrocarbon mixture 15 which in this example is aircraft kerosene is accommodated in the tank 10. A part of the hydrocarbon mixture 15 is removed from the tank 10 and fed to the separating device 35. Another part of the hydrocarbon mixture 15 is taken from the tank and burnt in the combustion machine 20, here an aircraft turbine, to produce therefrom thermal energy 25 and kinetic energy 30, in particular to drive the aircraft in which the apparatus 5 is arranged.

The invention is not limited to liquid hydrocarbon mixtures although that is preferred by virtue of the ease of handling. It is also possible to use hydrocarbon mixtures in gaseous or solid form. It will be appreciated that a corresponding consideration also applies to the dehydrogenatable compound, the dehydrogenated compound and the hydrocarbon mixture residue.

In the separating device 35, at least one dehydrogenatable compound is separated from the hydrocarbon mixture. Typical aircraft kerosene includes inter alia cyclohexane, methylcyclohexane, cis-decalin, trans-decalin, n-dodecane, tetralin, dipentene and diethylbenzene as dehydrogenatable compounds. In the present embodiment the separating device is equipped with an element 65 for fractionated distillation in order to separate cis-decalin and trans-decalin with an evaporation point of 194.6° C. and 185.5° C. respectively from the hydrocarbon mixture. Distillation is only one available separation option. A further alternative or supplemental possibility is in particular separating the dehydrogenatable compound from the hydrocarbon mixture residue by means of absorption and/or adsorption in or on a suitable sorption agent respectively, and feeding it to the further processing procedures. In accordance with the present invention however it is also possible to use other methods of separating off the dehydrogenatable compound, which seem suitable to the man skilled in the art. In the separation operation therefore, the hydrocarbon mixture fed to the separating device is divided into a part which has at least one dehydrogenatable compound, here cis-decalin and trans-decalin, and a hydrocarbon mixture residue. It is admittedly generally preferable for the dehydrogenatable compound or compounds to be completely separated from the hydrocarbon mixture 15; that however is not necessarily the case. The hydrocarbon mixture residue can thus also contain dehydrogenatable compounds. In the present case it is not out of the question for the hydrocarbon mixture residue to also still contain cis- or trans-decalin.

The dehydrogenatable compounds which have been separated off are fed to the dehydrogenating means 40 while the hydrocarbon mixture residue is passed by way of the second feed means 60 optionally into the tank 10 to the hydrocarbon mixture 15 or directly to the combustion machine 20. There is no need for both options to be available. In alternative configurations the hydrocarbon mixture residue can also be passed exclusively directly to the combustion machine 20 for combustion or only into the tank 10 for mixing with the hydrocarbon mixture 15 contained therein, and for subsequent combustion thereof. A further alternative or supplemental configuration involves providing a dedicated tank for the hydrocarbon mixture residue for at least intermediate storage of the hydrocarbon mixture residue.

The dehydrogenating means 40 of the present embodiment have a catalyst 70 for catalytic dehydrogenation of the dehydrogenatable compound or compounds.

In accordance with the invention the following catalysts are preferred for dehydrogenation individually or in combination: (a) metals selected from the group consisting of platinum (Pt), palladium (Pd), rhodium (Rh), osmium (Os), ruthenium (Ru), rhenium (Re), tungsten (W), iridium (Ir), molybdenum (Mo) and alloys thereof, (b) combinations of at least two of the aforementioned metals (bi- or oligolayer), more specifically respectively (i) in metallic form, (ii) on a carrier material, for example on a zeolite or on carbon, and/or (iii) as metallorganic complexes, such as for example metal carbonyl complexes. Alternatively or supplemental to catalytic dehydrogenation it is possible for example to use thermal dehydrogenation or another suitable method. If as in the present case there are a plurality of dehydrogenatable compounds in the hydrocarbon mixture 15 then advantageously special catalysts can be provided for each or individual dehydrogenatable compounds. In the dehydrogenation operation the respective (each) dehydrogenatable compound is split up into hydrogen and a dehydrogenated compound (or a plurality of such compounds). The hydrogen is fed to the fuel cell 50 where it is reacted in per se known manner to generate electrical energy 55. The water occurring in that case is collected in a water storage means 100 and can be used as service water in the aircraft. The dehydrogenated compound or compounds is or are passed by way of the first feed means 45 indirectly (via the tank 10) or directly to the combustion machine.

The analysis unit 80 determines the composition of the hydrocarbon mixture in the tank 10, for example by means of mass spectrometry, and communicates the detected composition in respect of which in particular the proportions of dehydrogenatable compounds are of interest to the control unit 75.

The mixing unit 90 provides a mixture of hydrocarbon mixture 15 (from the tank 10), dehydrogenated compound or compounds (provided by the dehydrogenating means 40) and hydrocarbon mixture residue (provided by the separating device 35) in the desired proportions. Desired properties of that mixture, for example the melting point in the case of aircraft kerosene as the hydrocarbon mixture 15 or the octane number in the case of automobile gasoline, are determined by means of the measuring unit 95. The values ascertained are also communicated to the control unit 75, more precisely to the calculating unit 85 of the control unit 75.

The calculating unit 85 is equipped with algorithms for calculating an optimised implementation in respect of time of the method. On the basis of that calculation, the parameters of which include the amount of hydrocarbon mixture fed to the separating device 35, the manner and extent of separation of the dehydrogenatable compound in the separating device 35, the manner and the time of the feed of the dehydrogenated compound and the hydrocarbon mixture residue to the combustion machine, the control unit 75 controls the method which is carried out in the apparatus. In that respect the control unit 75 influences the separating device 35 and the dehydrogenating means 40. In addition the control unit controls the first and second feed means 45, 60.

FIG. 2 diagrammatically shows a second embodiment of an apparatus according to the invention. The apparatus 105 includes a tank 110 connected to a separating device 135 by way of a filter 112, a pump 113 and a heat exchanger 114. The tank 105 is also connected by way of a valve 123 to a combustion machine 120. The combustion machine 120 is a kerosene burner as is typically a component part of a jet engine used in aircraft. The burner 120 receives its feed air from a compressor stage 121 through a further heat exchanger 122. The apparatus 105 further has a cooling circuit 138. In addition the apparatus 105 includes dehydrogenating means 140 which are connected to the separating device 135 and which lead to a separating unit 142 connected by way of first feed means 145 to the tank and via a valve 143 to a fuel cell 150. The separating device 135 is further connected by way of second feed means 160a, 160b to the tank 110 and includes a first distilling element 165a, a valve 136, a heat exchanger 137, a second distilling element 165b, a further heat exchanger 139 and a desulfurisation unit 141.

The tank 110 is designed to accommodate the hydrocarbon mixture (not shown), for example kerosene. From the tank 110 a conduit with the valve 123 for regulating the hydrocarbon feed flow leads to the burner 120. The burner 120 receives the air required for combustion of the hydrocarbons, by a compressor stage 121, by way of a heat exchanger 122. The purpose of that heat exchanger 122 is described hereinafter. Upon combustion of the hydrocarbons fed to the burner 120, thermal energy 125 and kinetic energy 130 are produced. At least a part of the thermal energy 125 is fed to the heat exchangers 114 and 139.

A part of a hydrocarbon mixture in the tank 110 is cleaned in the filter 112 and fed to a pump 113. The pump 113 conveys a part of the hydrocarbon mixture through the heat exchanger 114 in which thermal energy 125 is transferred from the exhaust gases of the burner 120 to the hydrocarbon mixture. In the first distilling element 165a a light component which is gaseous at the process temperature is separated from the heavier liquid component of the hydrocarbon mixture. The liquid hydrocarbon mixture is fed to the tank 110 by way of the second feed means 160a and is there mixed with the remaining hydrocarbon mixture. The gaseous component is passed for pressure adjustment through the valve 136 and for cooling through the heat exchanger 137. In the heat exchanger heat is given off to the cooling circuit 138. The cooled component which was previously completely and now still partially in gas form is passed from the heat exchanger 137 into the second distilling element 165b in which the dehydrogenatable compound is separated from lower-boiling components which in turn are passed with the second feed means 160b through the heat exchanger 122 to the tank. The heat exchanger 122 serves to cool those gaseous components to such an extent that they can be added in liquid form to the hydrocarbon mixture in the tank 110. The liquid component containing the at least one dehydrogenatable compound, in this example methylcyclohexane, is now passed from the second distilling element 165b to the heat exchanger 139 and is there heated again by the waste gas from the burner 120 so as to set desired temperature and pressure conditions. Before the dehydrogenatable compound is passed to the dehydrogenating means 140, desulfurisation is effected in the desulfurisation unit 141. Sulfur represents a catalyst poison and is present in conventional kerosene at levels of concentration of up to 3000 ppm. It will be noted however that the most resistant catalysts known at the present time are only suitable for levels of sulfur concentration of up to a few ppm. Distillation or generally separation of the dehydrogenatable compound generally already provides that the sulfur concentration falls. To achieve a further reduction and as an additional safety measure for the catalysts used in the dehydrogenating means 140, the desulfurisation unit 141 is however still provided, as shown in FIG. 2. The further desulfurised dehydrogenatable compound is passed to the dehydrogenating means 140 in which hydrogen is partially separated therefrom. In the separating unit 142 the hydrogen which has been separated off is separated from the dehydrogenated compound, in the case of methylcyclohexane therefore toluene. The dehydrogenated compound is passed into the tank 110 by way of the first feed means 145. A valve 143 serves for adjusting the pressure of the hydrogen fed to the fuel cell 150. Electrical energy 155 is generated in the fuel cell 150 by reaction of the hydrogen.

FIG. 3 shows a flow chart to illustrate a first embodiment of the method according to the invention. In a first step 305 a hydrocarbon mixture having at least one dehydrogenatable compound is provided. That can be effected for example as described hereinbefore in a tank. Then in a subsequent step 315 at least a part of the dehydrogenatable compound is separated from the hydrocarbon mixture. A possible method of separation comprises for example appropriately controlled distillation. In particular the above-described apparatuses include devices which can serve for the separation operation. It is however also possible to use other methods with which the man skilled in the art is familiar for the separation procedure. The step 315 is then followed by a step 325 for producing hydrogen from the dehydrogenatable compound which has been separated off, by dehydrogenation. The above-described dehydrogenating means are preferably suitable for that purpose. Catalytic dehydrogenation is particularly preferred. The hydrogen produced in the dehydrogenation operation is reacted in step 355 to produce electrical energy. The dehydrogenated compound which remains in the dehydrogenation operation is fed in step 345 indirectly or directly to the combustion machine and can there be reacted jointly or separately to produce thermal and/or kinetic energy. In parallel with the aforementioned steps a part of the hydrocarbon mixture can also be fed directly to the combustion machine and burnt there to produce thermal and/or kinetic energy (step 335). In a higher-order method section 365 therefore hydrocarbons of possibly different compositions are burnt to produce energy.

FIG. 4 shows a flow chart to illustrate a second embodiment of the method according to the invention. In a first step 405 kerosene is provided as a hydrocarbon mixture having at least one dehydrogenatable compound. In step 415 the dehydrogenatable compound is at least partially separated from the provided kerosene or a part thereof. After that therefore there are on the one hand the dehydrogenatable compound (possibly together with other compounds) and on the other hand the hydrocarbon mixture residue. In a feed step 470 the hydrocarbon mixture residue is passed to the combustion step 465. In addition a given amount of the kerosene provided can also be fed to the combustion step (step 410). The dehydrogenatable compound is dehydrogenated in step 425, preferably with the assistance of one or more catalysts. That therefore gives hydrogen which is reacted in step 455 in the fuel cell to produce electrical energy. The dehydrogenated compound produced in the dehydrogenation operation 425 is fed in step 445 to the combustion machine for combustion 465. In parallel with the foregoing steps, the kerosene is analysed in respect of its composition in step 485 after provision 405 of the kerosene. In addition in step 475 a part of the kerosene provided, a part of the hydrocarbon mixture residue remaining in the separation operation 415 and a part of the compound dehydrogenated in step 425 are mixed in a predetermined ratio. The mixture produced in that way is investigated and measured in respect of predetermined properties, for example freezing or melting point (step 480). The results of the measurement operation from step 480 and analysis from step 485 are incorporated into a calculation (step 490), the result of which is used as a basis for control of the separation operation (step 415), the dehydrogenation operation (step 425), the feed of the hydrocarbon mixture residue to the combustion operation (step 470) and the dehydrogenated compound to the combustion operation (step 445), in step 495. It is possible in that way to ensure that the totality of the hydrocarbons fed to the combustion machine has properties within predetermined tolerance ranges and thus fulfils the demands of the technology or the standards made on a fuel for the combustion machine.

The embodiments described herein serve to illustrate the invention. Individual ones or a plurality of features of the described embodiments can also be combined together in accordance with the invention in other ways than that illustrated.

In accordance with the invention a hydrocarbon-based fuel can be used as a liquid hydrogen carrier source, from which for example it is possible to remove by means of fractionated distillation a given fraction or a plurality of fractions containing at least one dehydrogenatable compound. The dehydrogenatable compound is dehydrogenated and the residue is fed for example to the fuel again.

The invention makes it possible to provide hydrogen in a good state of purity, with a low level of system complexity, by means of a compact and light installation, at comparatively low working temperatures (<350° C.). With sufficiently good separation it is possible to dispense with an additional desulfurisation operation. The invention allows a long service life to be achieved, with a low level of maintenance complication and expenditure.

A suitable hydrocarbon mixture for use in accordance with the invention is for example Jet A1 kerosene which is typically used in civil aviation. In accordance with the technical specifications involved it usually has the following properties:

| | |
|---|---|
| Acidity, overall | 0.1 mg KOH/g (max.) |
| Aromatics | 22% by volume (max.) |
| Sulfur, overall | 0.3% by weight (max.) |
| Sulfur, mercaptans | 0.003% by weight (max.) |
| Flashpoint | 38° C. (min.) |
| Density | 775-840 kg/m³ (at 15° C.) |
| Freezing point | −47° C. (max.) |
| Electricity conductivity | 50-450 pS/m. |

Jet A1 kerosene contains n-paraffins, isoparaffins, naphthenes and aromatics. A typical composition is as follows:

| C-number | Representative hydrocarbons |
|---|---|
| 6-8 | cyclohexane, methylcyclohexane, n-octane, 2- |
| | methylheptane, 1-methyl-1-ethylpentane, xylene |
| 9-10 | trans-decalin, cis-decalin, tetralin, naphthalene |
| 11-12 | n-dodecane, 2-methylundecane, 1-ethylnaphthalene, n- |
| | hexylbenzene |
| 13-16 | n-hexadecane, 2-methylpentadecane, n-decylbenzene |

Taking an Airbus A330-200 as the reference aircraft with a flight cycle of 8.7+2.6 hours, a tank volume of 112+5.3 t and a range of 12225+275 km, an energy demand of 500 kW, a λ-factor of 1.2 and on the assumption that 10% of the kerosene used can be used as a hydrogen source, with the following educt-product pairings, the results are as follows:

| | | | |
|---|---|---|---|
| Cyclohexane C₆H₁₂ | → | benzene C₆H₆ | 13.4 h |
| Methylcyclohexane C₇H₁₄ | → | toluene C₇H₈ | 13.4 h |
| Cis-decalin C₁₀H₁₈ | → | naphthalene C₁₀H₈ | 22.3 h |
| Trans-decalin C₁₂H₂₆ | → | naphthalene C₁₀H₈ | 22.3 h |
| n-Dodecane C₁₂H₂₆ | → | C₁₂H₁₈ | 17.5 h |

It can be seen that in accordance with the invention it is possible to provide adequate energy for a flight cycle.

What is claimed is:

1. An apparatus for energy production from a hydrocarbon mixture having at least one dehydrogenatable compound, in particular from a hydrocarbon-based fuel, preferably from kerosene, comprising:
a tank for providing the hydrocarbon mixture, and
a combustion machine connected to the tank for combustion of hydrocarbons for producing thermal and/or kinetic energy,
characterised in that the apparatus further comprises:
a separating device for at least partially separating the at least one dehydrogenatable compound from the hydrocarbon mixture,
a dyhydrogenator that produces hydrogen from the separated dehydrogenatable compound by dehydrogenation,
a first feeder that feeds the dehydrogenated compound to the combustion machine, and
a fuel cell for producing electrical energy, with reaction of the hydrogen obtained.

2. An apparatus according to claim 1 further comprising
a second feeder that feeds the hydrocarbon mixture residue remaining upon separation of the at least one dehydrogenatable compound to the combustion machine.

3. An apparatus according to claim 1 wherein the separating device includes a distillation device for distillative separation of a fraction containing the dehydrogenatable compound and/or a sorption device for sorptive separation of the at least one dehydrogenatable compound from the hydrocarbon mixture.

4. An apparatus according to claim 1 wherein the separating device is adapted to at least partially free the dehydrogenatable compound in the separation operation from a predetermined impurity.

5. An apparatus according to claim 1 wherein the first feeder is adapted to feed the dehydrogenated compound and the hydrocarbon mixture residue respectively to the combustion machine via the tank.

6. An apparatus according to claim 1 wherein the apparatus is adapted for processing an aircraft kerosene as the hydrocarbon mixture and the separating device is adapted to separate one or more dehydrogenatable compounds from the hydrocarbon mixture, which are selected from the group consisting of cyclohexane, methylcyclohexane, cis-decalin, trans-decalin, n-dodecane, tetralin, dipentene, diethylbenzene and mixtures thereof.

7. An apparatus according to claim 1 (5, 105) wherein the dyhydrogenator includes a catalyst for catalytic dehydrogenation of the dehydrogenatable compound.

8. An apparatus according to claim 1 further comprising:
a control unit for controlling the separating device, and
an analysis unit connected to the control unit for analysing the composition of a provided hydrocarbon mixture in operation,
wherein the control device is adapted in operation to control the amount of the hydrocarbon mixture, that is fed to the separating device, and separation of the at least one dehydrogenatable compound therefrom on the basis of the composition determined by the analysis unit.

9. An apparatus according to claim 8 wherein the control unit is further adapted in operation to ensure production of a predetermined amount of hydrogen per unit of time.

10. An apparatus according to claim 8 wherein the control unit is further adapted in operation to ensure production of hydrogen for a predetermined period of time.

11. An apparatus according to claim 8 wherein the control device is further adapted to control the manner of feeding the dehydrogenated compound and/or the hydrocarbon mixture residue remaining upon separation of the at least one dehydrogenatable compound to the combustion machine.

12. An apparatus according to claim 8 wherein the control unit is further adapted in operation to ensure that predetermined properties of the totality of hydrocarbons, that is fed to the combustion machine, lie within predetermined tolerance ranges.

13. An apparatus according to claim 8 wherein the control unit has a calculating unit which is adapted to determine an implementation in respect of time of
the amount of hydrocarbon mixture fed to the separating device,
separation of the at least one dehydrogenatable compound in the separating device, and/or
the way of feeding the dehydrogenated compound and/or the hydrocarbon mixture residue remaining upon separation of the at least one dehydrogenatable compound to the combustion machine on the basis of the composition determined by the analysis unit in which it is ensured that for a predetermined period of time in operation predetermined properties of the totality of hydrocarbons, that is fed to the combustion machine, lie within predetermined tolerance ranges.

14. An apparatus according to claim 1 further comprising:
a mixing unit for the production of a mixture from
the hydrocarbon mixture,
the hydrocarbon mixture residue remaining upon separation of the at least one dehydrogenatable compound, and
the dehydrogenated compound
in predetermined portions, and
a measuring unit that measures predetermined properties of the mixture.

15. An apparatus according to claim 1 further comprising:
a water storage device that receives water produced in the fuel cell.

16. A system for producing energy comprising:
an apparatus according to claim 1, and
a hydrocarbon mixture having at least one dehydrogenatable compound, in particular a hydrocarbon-based fuel, preferably kerosene.

17. A method of producing energy from a hydrocarbon mixture having at least one dehydrogenatable compound, in particular from a hydrocarbon-based fuel, preferably from kerosene, comprising the steps:
providing the hydrocarbon mixture, and
burning hydrocarbons for producing thermal and/or kinetic energy, characterised in that the method includes as further steps:
at least partially separating at least one predetermined dehydrogenatable compound from the hydrocarbon mixture,
producing hydrogen from the separated dehydrogenatable compound by dehydrogenation,
feeding the dehydrogenated compound to the combustion machine, and
reacting the hydrogen produced to produce electrical energy.

18. An apparatus according to claim 2 wherein the second feeder is adapted to feed the dehydrogenated compound and the hydrocarbon mixture residue respectively to the combustion machine via the tank.
